(19) United States
(12) Patent Application Publication
(10) Pub. No.: US 2019/0211973 A1
(43) Pub. Date: Jul. 11, 2019

(54) METHOD AND DEVICE FOR DETECTING AN AMOUNT OF GAS IN A CALIBRATION-CAPABLE MANNER

(71) Applicant: LINDE AKTIENGESELLSCHAFT, Munchen (DE)

(72) Inventors: Thomas KNOCHE, Gaissach (DE); Markus RASCH, Sulz im Wienerwald (AT); Simon SCHAFER, Pullach (DE); Sarah GRUBER, Perchtoldsdorf (AT)

(73) Assignee: LINDE AKTIENGESELLSCHAFT, Munchen (DE)

(21) Appl. No.: 16/323,994

(22) PCT Filed: Aug. 3, 2017
(86) PCT No.: PCT/EP2017/000941

§ 371 Date: Feb. 7, 2019

(30) Foreign Application Priority Data
Aug. 9, 2016 (DE) 102016009674.8

(51) Int. Cl. F17C 13/02

(52) U.S. Cl. CPC F17C 13/023; F17C 13/028; F17C 2221/012; F17C 2227/0325; F17C 2270/0139; F17C 2250/0443; F17C 2250/0495; F17C 2265/06; F17C 2250/0426

(57) ABSTRACT

The invention relates to a method and to a device for determining an amount of gaseous fuel, which during a refueling process at a gas station has been transferred into a storage tank via a gas pump (3) and a filling hose (4) connected thereto, wherein in the gas pump (3) of the gas station, a flow meter (F) is provided, which during the filling of the storage tank detects the amount of fuel dispensed. Once the filling is completed, the filling hose (4) is depressurized, and the amount of fuel, which has not been transferred into the storage tank due to the depressurization, is detected, and this amount is subtracted from the amount detected by the flow meter (F).

The invention pertains to a method for determining an amount of gaseous fuel, which during a refueling process at a filling station has been transferred into a storage tank by means of a fuel dispenser and a filling hose connected thereto, wherein a flow meter is provided in the fuel dispenser of the filling station and determines the amount of fuel dispensed during the filling of the storage tank, and wherein the filling hose is depressurized once the filling process is completed.

An increasing number of vehicle manufacturers offer motor vehicles that run on the gaseous fuels such as natural gas, liquefied petroleum gas or hydrogen. This not only includes passenger cars, but also buses, trucks and forklifts. The number of filling stations, particularly the number of hydrogen filling stations, increases in parallel with the increasing number of vehicles that run on compressed gases. Hydrogen filling stations are more frequently used by private customers. Due to the higher pressures and lower temperatures of hydrogen in comparison with natural gas or liquefied petroleum gas, new developments of refueling processes and other devices are required, in particular, for the refueling with hydrogen. The temperature and the pressure of the hydrogen have to be exactly controlled in order to ensure that the storage tanks of the vehicles are filled in a controlled and safe manner. As a result, the measuring accuracy of hydrogen filling stations with respect to the temperature and the pressure of the hydrogen to be dispensed is subject to increasing requirements.

Among other things, a hydrogen filling station comprises a storage tank, in which the hydrogen can be stored in liquid and/or gaseous form. Liquid storage is preferred because the storage density is greater. However, the low temperatures of the liquid hydrogen are disadvantageous in this case. It is also common practice to provide a gas reservoir, in which the hydrogen is stored at an ambient temperature, but compressed to a pressure of up to 1000 bar, particularly up to 910 bar.

Modern hydrogen vehicles are preferably equipped with a fuel tank for storing gaseous hydrogen at a pressure of 350 or 700 bar.

The hydrogen being filled into the fuel tank should have a filling temperature between −33 and −40° C. This temperature is specified by different standards and standard protocols.

This means that the liquid storage of hydrogen, as well as its gaseous storage, requires elaborate devices for conditioning the hydrogen.

Consequently, a hydrogen filling station typically also comprises at least one pump, particularly a cryopump if the hydrogen is stored in liquid form, multiple heat exchanging devices, multiple pressure control valves, particularly cryogenic high-pressure throttle valves, as well as temperature, pressure and flow controllers. A hydrogen filling station also comprises a fuel dispenser, at which the fuel nozzle and the corresponding filling hose are accessible for the customers. The fuel dispenser typically also comprises electronic devices, particularly for controlling the output and for billing the dispensed hydrogen.

Hydrogen filling stations, which are accessible to private customers, are subject to strict requirements with respect to the accuracy of the measurement of the dispensed amount of hydrogen. The customers, as well as the operators, require precise information on the dispensed amount of hydrogen.

Existing hydrogen filling stations were frequently constructed in the form of pilot facilities or are only accessible to individual major customers. Inaccuracies with respect to the temperature and the amount of the hydrogen dispensed during the refueling process were tolerated, temperature and pressure values were frequently estimated and the risks were minimized due to the provision for high safety factors.

However, this is no longer acceptable as the use of hydrogen as fuel continues to increase in the private sector.

Problems in the determination of the dispensed amount of hydrogen are primarily caused in that the measuring devices for the flow rate, the temperature and the pressure are installed in the fuel dispenser of a hydrogen filling station. At present, the dispensed amount of hydrogen is typically determined by means of flow meters, for example Coriolis flow meters. To this end, the refueling period is determined by means of the control in order to subsequently determine the amount of hydrogen dispensed within this time period.

In this case, the determined amount also includes the amount of hydrogen that is located in the filling hose between the fuel dispenser and the vehicle tank and no longer transferred into the tank due to the completion of the refueling process. In other words, this concerns the amount of hydrogen that is still located in the filling hose downstream of the shutoff valve, which interrupts the hydrogen supply after the completion of the refueling process, and prevented from escaping into the environment by a closing mechanism in a refueling coupler or fuel nozzle of. The filling hose is realized similar to conventional filling stations for liquid fuel, namely in the form of a flexible hose with a refueling coupler, wherein the section of the filling hose located within or on the fuel dispenser may also be realized in the form of a rigid hose or in the form of a pipeline. In this application, the term filling hose is used representative for the entire volume between the shutoff valve or flow meter and the fuel nozzle.

The currently realizable design of flow meters, which can withstand the high pressures and the low temperatures of the hydrogen, does not allow their integration into the hose or the refueling coupler in order to thereby reduce the distance between the vehicle tank and the flow meter.

The amount of hydrogen, which can no longer be transferred into the vehicle tank, has already been detected by the flow meter and is billed as a dispensed amount.

The closing mechanism or the seal in the fuel nozzle and the shutoff valve in the fuel dispenser are closed after the completion of the refueling process. Consequently, the filling hose is under high pressure after the refueling process has been completed. The hose therefore has to be depressurized before the refueling coupler can be separated from the motor vehicle. This is necessary for safety reasons on the one hand and for restoring the flexibility of the filling hose on the other hand. A refueling coupler under pressure typically cannot be decoupled for safety reasons. A hose under high pressure loses its flexibility and is difficult to handle. In order to make the refueling process as simple as possible, however, the flexibility of the filling hose has to be ensured before and after the refueling process such that the hose can be oriented toward the vehicle and connected to the storage tank as required before the refueling process starts and returned into the intended holder after the refueling process is completed.

Under these circumstances, exact billing of the dispensed gas amount is impossible because the measured and the calculated gas amounts always deviate. The expanded fuel amount can under the assumption of a complete refueling process be estimated by means of predefined temperature and pressure values from the refueling standards, but such estimates are also inaccurate. This results in disadvantages for the customer and for the operator. These methods are furthermore unsuitable for carrying out a calibration of the billing device with the required accuracy.

The invention is therefore based on the objective of disclosing a method, in which the gaseous fuel is precisely measured and therefore exactly billed.

With respect to the method, this objective is attained in that the amount of fuel, which has not been transferred into the storage tank due to the depressurization, is determined and this amount is subtracted from the amount determined by the flow meter.

With respect to the device for determining an amount of gaseous fuel dispensed during a refueling process at a filling station, which is installed in a fuel dispenser and connected to a filling hose, the above-defined objective is attained in that said device comprises a flow meter, to which the filling hose is connected, and a pipeline with an expansion valve, which branches off the filling hose.

The amount of fuel in the filling hose, which has not been transferred into the storage tank, is preferably determined in that a temperature value and a pressure in the filling hose are respectively determined after the completion of the refueling process and prior to the depressurization in order to determine a density of the hydrogen in the filling hose, in that the volume of the filling hose is known, and in that the dispensed amount of fuel, which has remained in the filling hose after the completion of the refueling process, is thereby determined.

The density of the expanded gaseous fuel p, is particularly calculated by means of a state equation that is familiar to a person skilled in the art. The required parameters temperature and pressure are determined after the completion of the refueling process and prior to the depressurization of the filling hose.

The amount of expanded gaseous fuel Mₑ is calculated by means of the formula: Mₑ=ρₑ·Vₑ. The volume Vₑ of the depressurized filling hose is known. The volume of the filling hose, i.e. the entire accessible region between the shutoff valve or flow meter, namely downstream thereof depending on subsequent positioning, and the fuel nozzle preferably amounts to between 0.2 and 1 liter.

The mass of gaseous fuel, which is still located in the filling hose, depends on the pipeline geometry, the pressure and the temperature and may lie between 0.1 and 100 g, particularly between 1 and 25 g. During the depressurization, this mass is advantageously discharged into the environment via a funnel or collected in a separate container.

In another preferred embodiment, the amount of fuel in the filling hose, which has not been transferred into the storage tank, is determined in that a temperature value in the filling hose is determined after the completion of the refueling process and prior to the depressurization and a pre-adjusted pressure value is used for determining a density of the fuel in the filling hose, in that the volume of the filling hose is known, and in that the dispensed amount of fuel, which has remained in the filling hose after the completion of the refueling process, is thereby determined. The pre-adjusted pressure value preferably is the maximum pressure of the vehicle tank. This calculation is based on the assumption that the storage tank is always completely filled. The deviations may therefore be small and tolerable depending on the calibration method.

In another preferred embodiment, the amount of fuel in the filling hose, which has not been transferred into the storage tank, is determined in that a pressure value in the filling hose is determined after the completion of the refueling process and prior to the depressurization and a pre-adjusted temperature value is used for determining a density of the fuel in the filling hose, in that the volume of the filling hose is known, and in that the dispensed amount of fuel, which has remained in the filling hose after the completion of the refueling process, is thereby determined. The fuel has a narrow temperature range because the refueling process is preferably carried out in accordance with a standardized refueling method. In such an embodiment, it is therefore possible to use a temperature value, which lies within this temperature range, as fixed temperature value. The thusly caused deviation may be tolerable depending on the required calibration accuracy.

The gaseous fuel is preferably hydrogen. In other embodiments of the invention, the gaseous fuel could also consist of natural gas, liquefied petroleum gas or other gases.

The flow meter is advantageously realized in the form of a Coriolis flow meter or a differential pressure flow meter. In this case, a mass flow is detected or a pulse is acquired depending on the measuring principle of the flow meter used.

In a preferred method and a preferred device, sensors are provided in or on the filling hose and determine a temperature value and a pressure value.

The pressure in the filling hose during the refueling process preferably lies between 0 and 875 bar, particularly between 350 and 810 bar. After the depressurization, the pressure in the filling hose lies between 0 and 2 bar.

All device components, as well as the control and billing units, particularly may be designed such that they are protected against manipulations. This prevents undesirable external manipulations of the control of the filling station or the billing process.

The advantages of the invention can be seen in that an exact amount of hydrogen can be billed to the customer. In addition, the operator of the filling station has precise information on how much hydrogen has been dispensed and how much hydrogen has been lost due to depressurization.

The disclosed method also allows a calibration of the filling station in conformity with applicable regulations because the measured amount of hydrogen corresponds to the amount of hydrogen being billed. The inventive method preferably also makes it possible to carry out the calibration for different amounts. This is particularly important if the receiver tank was still partially filled prior to the refueling process or no complete refueling process takes place.

In another inventive embodiment, the valve used for depressurizing the filling hose may be positioned upstream of the flow meter referred to the flow direction. When the filling hose is depressurized after the refueling process, the gas flows back through the flow meter. In this particular embodiment, the amount flowing back can be detected and subtracted from the previously measured amount. The shutoff valve, the expansion valve and the flow meter are advantageously arranged as close to one another as possible in order to largely minimize the amount of non-measured hydrogen.

In an alternative embodiment of the inventive idea, it is furthermore possible to integrate a flow meter into the exhaust pipe. According to this embodiment, the expanded amount is determined by means of this flow meter and subtracted from the amount of the flow meter upstream of the filling hose.

However, this is not sufficiently economical yet due to the high costs for flow meters and the low profitability of hydrogen filling stations.

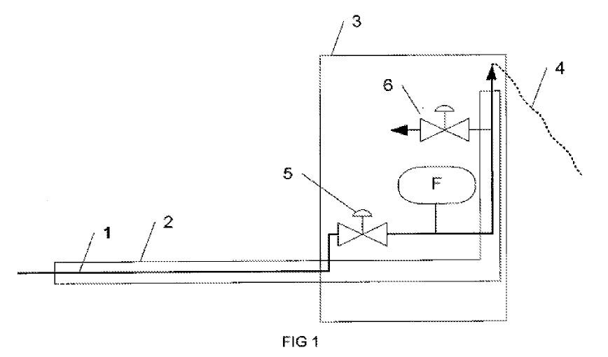

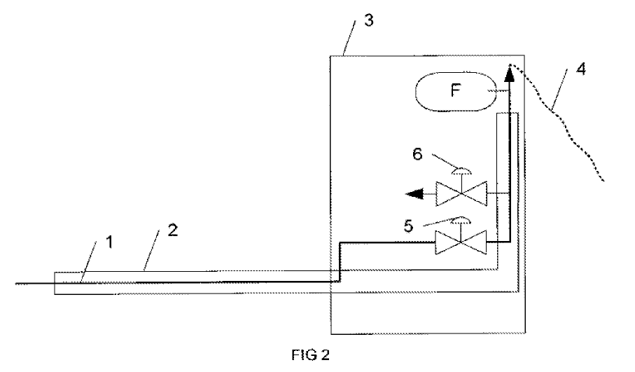

The invention is described in greater detail below with reference to the exemplary embodiments that are schematically illustrated in FIG. 1 and FIG. 2.

FIG. 1 shows a schematic design of a fuel dispenser for gaseous fuel with an expansion valve.

FIG. 2 shows an alternative schematic design of a fuel dispenser for gaseous fuel.

FIG. 1 schematically shows the most important components of the fuel dispenser of a filling station for gaseous fuel. The fuel is fed to the fuel dispenser 3 by means of a not-shown pump and/or from a storage tank via a pipe 1. The pipe 1 is provided with corresponding insulation 2. The insulation 2 serves for maintaining the fuel at the desired temperature. The temperature control is realized with methods that are familiar to a person skilled in the art and may take place at different locations in the filling station depending on the method used. The shutoff valve 5 is arranged on the pipeline 1 in the fuel dispenser 3. In the illustrated variation of the invention, the shutoff valve 5 is realized in the form of a pressure regulator. A flow meter F is arranged downstream of the shutoff valve 5 and a junction with an expansion valve 6 is located downstream of the flow meter. The filling hose 4 is realized in the form of a stable pipe within the fuel dispenser and in the form of a flexible hose outside the fuel dispenser and comprises a not-shown refueling coupler. The distances between the shutoff valve 5, the flow meter F and the expansion valve 6 should be chosen as small as possible.

In order to carry out the refueling process, the filling hose 4 is connected to a receiver tank, which typically consists of a vehicle tank, by means of a refueling coupler. The shutoff valve 5 is opened and gaseous fuel is conveyed into the receiver tank through the flow meter F. In the process, the flow meter F detects the dispensed amount of fuel. The expansion valve 6 is closed. The shutoff valve 5 is closed after the completion of the refueling process. A shutoff valve on the receiver tank is also closed in order to prevent the escape of already dispensed gas from the tank.

Subsequently, the temperature and the pressure in the filling hose are determined in order to thereby calculate a density, based on which the amount of fuel can be calculated. The expansion valve 6 is opened after the temperature and pressure measurements. The calculated amount is subtracted from the amount determined by the flow meter. The corrected amount is billed. In this way, an exact price for the dispensed fuel is calculated for the customer, as well as for the operator.

FIG. 2 shows an alternative embodiment. The components are essentially identical and therefore not described anew. This embodiment differs from the exemplary embodiment illustrated in FIG. 1 in that the junction with the expansion valve 6 is located directly downstream of the shutoff valve 5 and the flow meter F is arranged downstream of said junction. Consequently, the fuel remaining in the filling hose flows back through the flow meter F when the expansion valve 6 is opened after the refueling process. Depending on the type of flow meter used, the amount flowing back is either directly subtracted from the previously detected amount or detected separately and subtracted mathematically. This exemplary embodiment likewise ensures that only the actually dispensed amount of fuel is billed.

### LIST OF REFERENCE SYMBOLS

1 Pipe for fuel
2 Insulation
3 Fuel dispenser
4 Filling hose
5 Shutoff valve
6 Expansion valve
F Flow meter

1. A method for determining an amount of gaseous fuel, which during a refueling process at a filling station has been transferred into a storage tank by means of a fuel dispenser (3) and a filling hose (4) connected thereto, wherein
a flow meter (F) is provided in the fuel dispenser (3) of the filling station and determines the amount of fuel dispensed during the filling of the storage tank, and wherein
the filling hose (4) is depressurized once the filling process is completed,
characterized in that
the amount of fuel, which has not been transferred into the storage tank due to the depressurization, is determined and this amount is subtracted from the amount determined by the flow meter (F).

2. The method according to claim 1, characterized in that the amount of fuel in the filling hose (4), which has not been transferred into the storage tank, is determined in that
a temperature value (T) and a pressure (p) in the filling hose (4) are respectively determined after the completion of the refueling process and prior to the depressurization in order to determine a density (p) of the fuel in the filling hose (4), in that
the volume (V) of the filling hose (4) is known, and in that
the dispensed amount (M) of fuel, which has remained in the filling hose (4) after the completion of the refueling process, is thereby determined.

3. The method according to claim 1, characterized in that the amount of fuel in the filling hose (4), which has not been transferred into the storage tank, is determined in that
a temperature value (T) in the filling hose (4) is determined after the completion of the refueling process and prior to the depressurization and a pre-adjusted pressure value is used for determining a density (p) of the fuel in the filling hose (4),
in that the volume (V) of the filling hose (4) is known, and in that
the dispensed amount (M) of fuel, which has remained in the filling hose (4) after the completion of the refueling process, is thereby determined.

4. The method according to claim 1, characterized in that the amount of fuel in the filling hose (4), which has not been transferred into the storage tank, is determined in that
a pressure value (D) in the filling hose (4) is determined after the completion of the refueling process and prior to the depressurization and a pre-adjusted temperature value (T) is used for determining a density (p) of the fuel in the filling hose (4), in that
the volume (V) of the filling hose (4) is known, and in that
the dispensed amount (M) of fuel, which has remained in the filling hose (4) after the completion of the refueling process, is thereby determined.

5. The method according to claim 1, characterized in that the gaseous fuel is preferably hydrogen.

6. The method according to claim 1, characterized in that the flow meter (F) is a Coriolis flow meter or a differential pressure flow meter.

7. The method according to claim 1, characterized in that the pressure in the filling hose (4) lies between 0 and 710 bar, particularly between 350 and 700 bar, during the refueling process.

8. The method according to claim 1, characterized in that the pressure in the filling hose (4) lies between 0 and 2 bar after the depressurization.

9. A device for determining an amount of gaseous fuel dispensed during a refueling process at a filling station, which is installed in a fuel dispenser (3) and connected to a filling hose (4), characterized in that the device comprises a flow meter (F), to which the filling hose (4) is connected, and in that a pipeline with an expansion valve (6) branches off the filling hose (4).

10. The device according to claim 9, characterized in that sensors for pressure and temperature measurements are provided in or on the filling hose.
